(19) United States
(12) Patent Application Publication
(10) Pub. No.: US 2011/0093805 A1
(43) Pub. Date: Apr. 21, 2011

(54) DIGITAL CANVAS SYSTEM

(76) Inventors: Johan Hampus Ekhager, Uppsala (SE); Olof Edvin Berglof, Stockholm (SE)

(21) Appl. No.: 12/612,949

(22) Filed: Nov. 5, 2009

(30) Foreign Application Priority Data
Oct. 20, 2009 (SE) 0901355-8

(51) Int. Cl. G06F 3/048; G06F 15/16

(52) U.S. Cl. 715/769; 709/231

(57) ABSTRACT

The invention regards a system and a method which has a digital primary canvas hosted in a server displaying its content on a multiple of screens connected to a computer on a client canvas operated by participants in a specific project, and the client canvas is adapted to receive canvas external digital objects in the project through drag and drop. A client canvas has an instant message communication means utilizing the protocol to distribute digital communication between client canvases in real time. The primary canvas and the client canvas has a time line function where every consecutive time period on the time line is created by a timer means at a predetermined time.

### PRIOR APPLICATION

This is a US patent application that claims priority from Swedish patent application no. 0901355-8, filed 20 Oct. 2009.

### TECHNICAL FIELD

The present invention pertains to a system comprising a digital primary canvas hosted in a server and displaying the primary canvas and its content on a multiple of computer screens connected to a computer on a client canvas operated by participants in a specific project, and the client canvas being adapted to receive canvas external digital objects in the project through drag and drop. Moreover, the present invention presents a method therefore.

### BACKGROUND ART

There is a need for a tool to keep track on ideas and results emerging in a project. Commercial projects such as creating advertisements involve many creative persons that come up with a lot of suggestions, which have to be kept throughout the lifetime of the project until it is finalized. Moreover, the persons involved in a project often have their geographical place of business scattered over different places and cities. Some persons work at home and late in the evening.

A project requires that the persons involved in it meet on a regular basis to share their findings. Such meetings are moderated by a project manager and a secretary who gathers all the information shared and then documents it. The information shared can be almost of any type such as video, audio, pictures, data files, blueprints, computer aided design (CAD), paper and even post-it patches depending on the type of project. Furthermore, the information and ideas gathered in the project have to be scrutinized back and forth in time, which requires a bulk of binders and an efficient documentation and marking system in order to find documents in a fast mode.

Also, most projects have a customer paying for the finalized product. The end result of a project can sometimes be of a variety of different suggestions where the customer has to decide the most favourable of them. This requires that for instance the project manager has to present the findings of the project from start to end in a time line to the customer or to persons participating in the project.

There exists a tool for presentations to a live audience named Prezi® much like Powerpoint® but with a lot of new features for creating an interesting presentation. However, this tool lacks real time documentation in a timeline and is not intended to allow a group of persons to enter their findings and it also lacks the possibility to share information from different geographical places as described above.

It would be appreciated by persons involved in a project to have a tool that can solve problems such as those described in the former.

### SUMMARY OF THE INVENTION

The present invention has an aim among others to provide a digital canvas/whiteboard/blackboard/workspace for a multiple of participants in a project with a time line to add information on the canvas at different time periods, which can be accessed by going back and forth at time periods on the time line. A time period on the timeline is created at the laps of a predetermined time such as for instance every twenty-four hour. Moreover, the canvas according to the present invention has a unique instant message communication means that saves every communication between participants at a specific time period.

To solve problems described, the present invention sets forth a system comprising a digital primary canvas hosted in a server displaying its content on a multiple of computer screens, connected to a computer, on a client canvas provided from said server operated by participants in a specific project. The client canvas is adapted to receive canvas external digital objects in the project through drag and drop. Hereby, the invention comprises:

a protocol adapted to bear real time data signal streams between the server and the computers to place objects on the client canvases provided by the primary canvas;

external objects that are dragged and dropped from the world wide web are placed on the primary canvas through a link means, and local data from the computers is transmitted to the primary canvas and distributed to the client canvases by the protocol;

the client canvas with an instant message communication means utilizing the protocol to distribute digital communication between client canvases in real time;

a memory means connected to the primary canvas saving the digital communication as a communication object on the primary canvas, which distributes the communication object to the client canvases so that the communication can be retrieved through the communication object;

the primary canvas and the client canvas has a time line function where every consecutive time period on the time line is created by a timer means at a predetermined time; and

created time periods on the time line when operated display all objects placed on the primary canvas at the predetermined time, thus every time period displays its own unique set of objects placed on the canvas making up the history of the project from start to a deadline time period on the time line.

One embodiment of the present invention provides that the server has an encrypted mode and checks user authority through a database.

Another embodiment provides that the link means is a third party application placing an object on the primary canvas as a real object so that it can be retrieved without having to be streamed from a web page that eventually may go down or be closed.

A further embodiment provides that video and picture formats are converted by the server to a low resolution copy with a predetermined size, and audio and other file formats appear as an icon when drag and dropped to the canvas.

In one embodiment it is provided that the predetermined time is twenty-four hours.

Still another embodiment provides that objects placed on the canvas are tagged with a data file name, link to a source file on the server, x and y coordinates, time and user identity.

The present invention also sets forth a method for a digital primary canvas hosted in a server displaying its content on a multiple of computer screens, connected to a computer, on a client canvas provided from said server operated by participants in a specific project. The client canvas is adapted to receive canvas external digital objects in the project through drag and drop. The present invention method comprises:

bearing real time data signal streams through a protocol between the server and the computers to place objects on the client canvases provided by the primary canvas;

dragging and dropping external objects from the world wide web and placing them on the primary canvas through a link means, and transmitting local data from the computers to the primary canvas and distributing it to the client canvases by the protocol;

the client canvas through an instant message communication means utilizing the protocol to distribute digital communication between client canvases in real time;

saving the digital communication as a communication object on the primary canvas through a memory means connected to the primary canvas, which distributes the communication object to the client canvases so that the communication can be retrieved through the communication object;

the primary canvas and the client canvas has a time line function where every consecutive time period on the time line is created by a timer means at a predetermined time; and

displaying created time periods on the time line, and when the time periods are operated displaying all objects placed on the primary canvas at the predetermined time, thus every time period displays its own unique set of objects placed on the canvas making up the history of the project from start up to a deadline time period on the time line.

One embodiment of the present invention provides that the server operates in an encrypted mode and checks user authority through a database.

In another embodiment it provides that the link means is a third party application placing an object on the primary canvas as a real object so that it can be retrieved without having to be streamed from a web page that eventually may go down or be closed.

Yet one embodiment provides that video and picture formats are converted by the server to a low resolution copy with a predetermined size, and audio and other file formats appear as an icon when drag and dropped to the canvas.

### BRIEF DESCRIPTION OF THE DRAWINGS

Henceforth reference is had to the attached figures in the accompanying text of the description for a better understanding of the present invention with its embodiments and given examples, wherein:

FIG. 1 is schematically illustrating a canvas display according to the present invention;

FIG. 2 is schematically illustrating a system in accordance with the present invention; and

FIG. 3 is schematically illustrating an embodiment of FIG. 1 for notes and other communication provided on a canvas according to the present invention.

### DETAILED DESCRIPTION OF PREFERRED EMBODIMENTS

The present invention regards a digital canvas/whiteboard/blackboard/workspace for a multiple of participants in a project with a time line to add information on the canvas at different time periods, which can be accessed by going back and forth at time periods on the time line. A time period on the timeline is created at the laps of a predetermined time such as for instance every twenty-four hour. Moreover, the canvas according to the present invention has a unique instant message communication means that saves every communication between participants at a specific time period. A project in the sense of the present invention can be any kind of project for instance such that create any kind of physical products, advertisements, blue prints, movies, journals, Newspapers, books, designs, and other tasks that are conventionally related to a project.

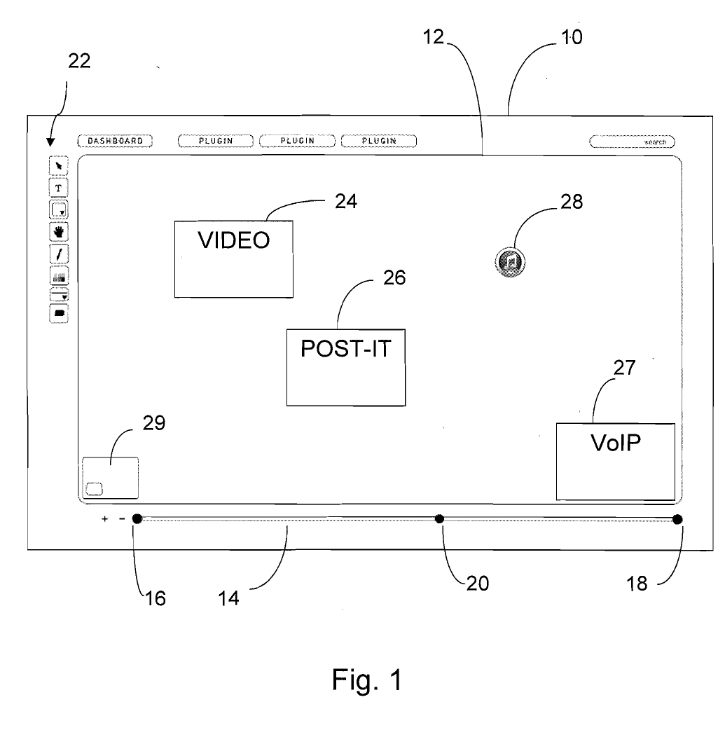

FIG. 1 depicts a computer screen 10 schematically showing a client canvas 12 of the present invention, timeline 14 with a start 16 and a deadline time period 18. A time period mark 20 is movable between the start 16 and end point time period 18 to display the canvas 12 for instance for different days in a project. As can be seen on the canvas a video 24, post-it patch 26, VoIP (Voice over Internet Protocol) connection 27 and an icon 28 have been dragged and dropped to the canvas 12 thus making up work that has been accomplished by one or more project participants utilizing the digital canvas 12 at the day marked by time period 20 on the timeline 14.

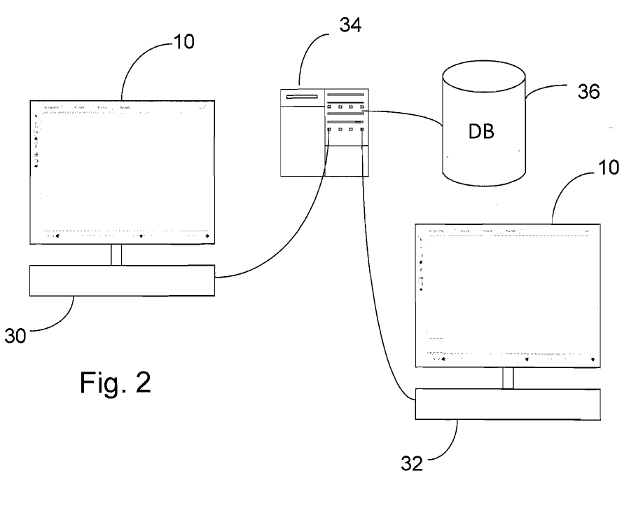

The system of the present invention, see FIG. 2, comprises a digital primary canvas (not shown) hosted in a server 34 or a plurality of servers displaying its content on a multiple of computer screens 10, which are connected to a computer 30, 32 on a client canvas 12. Canvases 12 are operated by participants in a specific project, and the client canvas 12 is adapted to receive canvas external digital objects 24, 28 in the project through drag and drop from the primary canvas. Furthermore, the system comprises a protocol such as RTP (Real-time Transportation Protocol) adapted to bear real time data signal streams between the server 34 and the computers 30, 32 to place objects 24, 26, 28 on the client canvases 12 provided by the primary canvas and the client canvas. The server 34 can host primary canvases for a multiple/plurality of different projects in one embodiment of the present invention.

External objects 24, 28 that are dragged and dropped from the World Wide Web are placed on the primary canvas through a link means from web pages. An ordinary link streams video down to the server 34 primary canvas and distributes it to the client canvases 12. Hence in one embodiment the link means is a third party application situated on the web browser utilized for placing an object on the primary canvas as a real object so that it can be retrieved without having to be streamed from a web page that eventually may go down or be closed.

Local data from the computers 30, 32 hard disk is transmitted to the primary canvas and distributed to the client canvases by the RTP protocol for instance embedded in a FTP (File Transfer Protocol) and then distributed to the client canvases 12.

Also, the client canvas is equipped with an instant message communication means utilizing the RTP protocol to distribute digital communication between client canvases 12 in real time through the primary canvas. A memory means connected to the primary canvas saves the digital communication as a communication object 27 on the primary canvas, which distributes the communication object 27 to the client canvases 12 so that the communication can be retrieved through the communication object 27, i.e. all conversation either audio or text is saved at each specific time period 16, 18, 20. Such an instant message communication means is innovative because it admits participants in a project to comment on the project in real time and retrieve it when for instance clicking on the time period 16, 18, mark/button. The digital canvases of the present invention could be compared with a laboratory book that keeps track of every day events and where no pages should be removed. As mentioned a communication object may for instance be a post-it patch 26 and/or VOIP (Voice over Internet Protocol) connection 27 for Internet telephony/chat or another known technique to communicate such as through a laptop webcam, or other known chat communication methods.

The primary canvas and the client canvas 12 has a time line function 14 where every consecutive time period 16, 18, 20 on the time line 14 is created by a timer means/clock/counter, as known to a person skilled in the art, at a predetermined time, and creates time periods 16, 18, 20 on the time line 14, which when operated/clicked on or otherwise entered displays all objects placed on the primary canvas at the time period 16, 18, 20. Thus every time period 16, 18, 20 displays its own unique set of objects 24, 26, 27, 28, 29 placed on the canvas 12, which illustrates the history of the project from a start to a deadline time period 18 on the time line 14. The predetermined time may be decided to a time suitable for each project but preferably set to twenty-four hours/a day, whereby the timer means creates a new time period every day. Although only three time periods are depicted in the drawings it is appreciated that there a lot of time periods on the time line 14 for instance depending on how many days a project is set to.

The client canvas 12 is provided a toolbar 22 utilized to operate functions on the canvas 12. A canvas 12 in the sense of the present invention is a visual workspace where objects/items 24, 26, 28 are added and/or created. An object can be added in at least two different manners such as internal objects through the toolbar 22 of for instance the type post-it patches, text/written objects, and all kinds of graphic forms. The other manner is an external, whereby external objects such as for instance video 24, designs, pictures, and audio data files 26 are added to the canvas 12. Preferably the size of a primary canvas is such that it does not interfere with the workflow of a user.

The present invention utilizes drag and drop to add/place objects 24, 26, 28 on the canvas. As known to a person skilled in the art drag and drop is a computer graphic user interface which acts when clicking on a virtual object and dragging it to another place/position or to another virtual object. When an object is dragged to the primary canvas and distributed to the client canvas 12 of the present invention from a local hard disk or the WWW, the data files dragged are forced to the server 34 preferably encrypted in the server 34, encrypted mode of the server 34 in the system of the present invention, which through a database verifies that the user of the client canvas 12 is authorized to load data files to the primary canvas to be distributed to the client canvases 12.

FIG. 2 of the present invention schematically illustrates one embodiment of the system of the present invention with two computer screens 10 with each one client canvas 12 for a specific project. It is appreciated that such a screen 10 can be available for all project participants and is not restricted to two. The screens 10 are connected to computers 30, 32 having known conventional functions and features. The screens 10 can also be connected to a main frame computer (not shown). In accordance with the present invention all internal objects from computer hard disks and the external from for instance WWW are dragged and dropped and operated by the server 34 before placed on the client canvas 12. Hereby, a database 36 is utilized to check if participants in a project are authorized to be so through for instance name, user-id, password and the like.

In accordance with the present invention it provides an innovative function to determine if a data signal file emanates from a users local hard disk or the WWW when utilizing drag and drop to a canvas 12. If a data file object 24, 26, 28 is added from a local computer 30, 32 hard disk it is uploaded to the server 34, which operates on it via for instance FTP (File Transfer Protocol). Video 24 and pictures are converted by the server which in one embodiment of the present invention positions a low resolution copy of the object with a predetermined size, length by height (L×H), on the canvas 12, and audio and other data file formats as clickable icons 28. It is in a low resolution mode to save computer speed, but can also show high resolution objects when called upon by for instance clicking on a tool bar 22 button.

Regarding objects from the WWW for instance from a homepage, the original data file object to be dragged and dropped is linked from the homepage to the server which determines a predetermined size (L×H) to video 24 and picture files. Video 24 and Picture files can be played or shown by clicking on a button in the toolbar 22. By copying the link to the video 24 or picture file the system of the present invention recognizes the format and streams the video or shows the picture(-s). One embodiment of the present invention utilizes a primary canvas in the size of approximately 5 by 5 m (5×5 m) or 15000 by 15000 pixels (15000×15000 pixels) but the present invention is not limited to this size, thus other sizes are possible. To clarify, if the client canvas is displayed on a computer with a small screen 10 such as a laptop, the tool bar 22 pan and zoom in and out buttons are utilized to display objects in a practical size for a user on the client canvas 12. In one embodiment, preferably the client canvas 12 is accessed from the server 34 like a webpage by every participant in a project. In another embodiment some software to produce the client canvas 12 can be stored as client software in the computers 30, 32.

As mentioned in one embodiment of the present invention it utilizes a protocol such as for instance RTP (Real-time Transportation Protocol) specified to bear data signal streams in real time. This provides that everything that is made on the canvas is in real time, and provides that all participants/members of a group/project utilizing a canvas 12 are able to see changes and objects added at the same time as every object placed on a client canvas 12 is distributed to it by the server 34 primary canvas. This feature admits users to work on distance, i.e., users do not necessarily work at the same geographical spot.

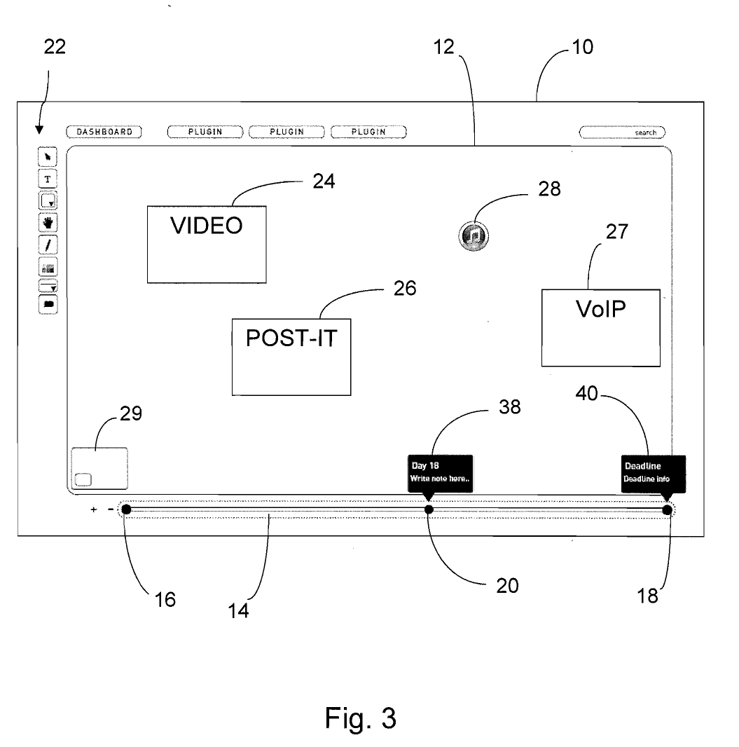

Another embodiment provides, as mentioned, that the canvas 12 has a time line function 14 for a specific project for instance positioned beneath the canvas object area. This can be regarded as a substitute to the conventional month based calendar display. At the different time periods 20 between and at a time line start date 16 and an end date 18 (deadline), dates and notes that users add can be seen. See FIG. 3. The time line 14 can be colored between time periods 16 to 20 clarifying to where the project has reached in time. A note 38, 40 comprising for instance the day of the project at time period 20, herein day 18, is marked and a user can add notes by e.g. double clicking at a specific time period in the project with for instance a computer mouse or other like cursor/pointing function. It is favorable with the timeline 14 that the system of the present invention displays and stores objects 24, 26, 28 and the work in progress for every day or other predetermined time. The work in progress can be viewed day by day through a means for that purpose e.g. by left clicking with a mouse button on a time period 16, 18, 20. Furthermore, the time line 14 can be played in the same manner as conventionally a video is displayed on a computer screen, for example, from the start date 16 to the latest active date 20 or to the end date 18 of a project if that date has been reached. Thus there are at least three alternatives to view the work in progress for instance by clicking on a play button, dragging with a computer mouse in the time line, or to click on a specific time period for a day.

An embodiment provides that a project is tagged with a project name, and added to the project; name tags are created belonging to each day of the project from the start date to the end date. When an object is added to the canvas, the object can be tagged with a data file name, link to a source file on the server 34, x and y coordinates, time, and user. This may be accomplished through the use of meta data.

Other embodiments comprised by the toolbar 22 are those conventionally found to edit objects 24, 26, 28 or to control the client canvas objects such as text editor, pan function, tools for drawing and having a set of predetermined shapes, colors, moving, scaling, and rotating of objects and the like. There is also provided a search function to search text.

The present invention is not restricted to the examples and given embodiments presented above. A person skilled in the art is able to derive further possible embodiments by the attached set of claims.

1. A system comprising a digital primary canvas hosted in a server displaying content on a multiple of computer screens, connected to a computer on a client canvas provided from said server operated by participants in a specific project, and said client canvas being adapted to receive canvas external digital objects in said project through drag and drop, comprising:
a protocol adapted to bear real time data signal streams between said server and said computers to place objects on said client canvases provided by said primary canvas;
external objects that are dragged and dropped from the world wide web are placed on said primary canvas through a link means, and local data from said computers is transmitted to said primary canvas and distributed to said client canvases by said protocol;
said client canvas having an instant message communication means utilizing said protocol to distribute digital communication between client canvases in real time;
a memory means connected to said primary canvas saving the digital communication as a communication object on the primary canvas, which distributes said communication object to said client canvases so that the communication can be retrieved through said communication object;
said primary canvas and said client canvas has a time line function where every consecutive time period on said time line is created by a timer means at a predetermined time; and
created time periods on said time line when operated display all objects placed on said primary canvas at said predetermined time, thus every time period displays its own unique set of objects placed on said canvas making up the history of said project from start to a deadline time period on said time line.

2. A system according to claim 1, wherein said server has an encrypted mode and checks user authority through a database.

3. A system according to claim 1, wherein said link means is a third party application placing an object on said primary canvas as a real object so that it can be retrieved without having to be streamed from a web page that eventually may go down or be closed.

4. A system according to claim 1, wherein video and picture formats are converted by said server to a low resolution copy with a predetermined size, and audio and other file formats appear as an icon when drag and dropped to said canvas.

5. A system according to claim 1, wherein said predetermined time is twenty-four hours.

6. A system according to claim 1, wherein objects placed on canvases are tagged with a data file name, link to a source file on the server, x and y coordinates, time and user identity.

7. A method comprising a digital primary canvas hosted in a server displaying its content on a multiple of computer screens, connected to a computer, on a client canvas, provided from said server operated by participants in a specific project, and said client canvas being adapted to receive canvas external digital objects in said project through drag and drop, said method comprising:
bearing real time data signal streams through a protocol between said server and said computers to place objects on said client canvases provided by said primary canvas;
dragging and dropping external objects from the world wide web and placing them on said primary canvas through a link means, and transmitting local data from said computers to said primary canvas and distributing it to said client canvases by said protocol;
said client canvas through an instant message communication means utilizing said protocol to distribute digital communication between client canvases in real time;
saving the digital communication as a communication object on the primary canvas through a memory means connected to said primary canvas, which distributes said communication object to said client canvases so that the communication can be retrieved through said communication object;
said primary canvas and said client canvas has a time line function where every consecutive time period on said time line is created by a timer means at a predetermined time; and
displaying created time periods on said time line, and when said time periods are operated displaying all objects placed on said primary canvas at said predetermined time, thus every time period displays its own unique set of objects placed on said canvas making up the history of said project from start to a deadline time period on said time line.

8. A method according to claim 7, wherein said server operates in an encrypted mode and checks user authority through a database.

9. A method according to claim 7, wherein said link means is a third party application placing an object on said primary canvas as a real object so that it can be retrieved without having to be streamed from a web page that eventually may go down or be closed.

10. A method according to claim 7, wherein video and picture formats are converted by said server to a low resolution copy with a predetermined size, and audio and other file formats appear as an icon when drag and dropped to said canvas.
